(19) United States
(12) Patent Application Publication
(10) Pub. No.: US 2015/0231481 A1
(43) Pub. Date: Aug. 20, 2015

(54) EXERCISE APPAREL WITH LINK TO EXERCISE ROUTINE

(71) Applicants: Christopher Jones, Ashburn, VA (US); Susan Jones, Ashburn, VA (US)

(72) Inventors: Christopher Jones, Ashburn, VA (US); Susan Jones, Ashburn, VA (US)

(21) Appl. No.: 14/181,211

(22) Filed: Feb. 14, 2014

(51) Int. Cl. A63B 71/06; G06K 19/06

(52) U.S. Cl. CPC A63B 71/0619; G06K 19/06028; G06K 19/06037

(57) ABSTRACT

Exercise apparel including a machine-readable label is provided. The machine readable label may include data. The data may include an exercise routine. A computer, such as a smart phone, tablet, desktop, laptop, and the like may read the machine-readable label and display the exercise routine to a user.

### BACKGROUND OF THE INVENTION

The present invention relates to exercise apparel and, more particularly, to exercise apparel that links a user to an exercise routine.

Physical exercise is any bodily activity that enhances or maintains physical and overall health and wellness. It is performed for various reasons including strengthening muscles and the cardiovascular system, honing athletic skills, weight loss or maintenance, as well as for the purpose of enjoyment. Currently, an athlete must use the internet and perform online research to obtain a suitable exercise routine. The athletes may search the internet based on their interest and activity level to receive customized exercises.

As can be seen, there is a need for an easier method of accessing exercise routines.

### SUMMARY OF THE INVENTION

In one aspect of the present invention, a system for accessing an exercise routine comprises: an apparel comprising a machine-readable label comprising data, wherein the machine readable label is disposed on a surface of the apparel; and a computer comprising a user interface and configured to read the machine-readable label and display the data, wherein the data comprises at least one of access to an exercise routine and an exercise routine.

In another aspect of the present invention, a method of providing an exercise routine comprises: providing an apparel comprising a machine-readable label comprising data, wherein the machine readable label is disposed on a surface of the apparel; prompting a user to enter the machine readable label into a computer by at least one of manually entering the machine readable label and scanning the machine readable label; displaying a exercise routine on the computer once the machine readable label has been entered into the computer.

In another aspect of the present invention, an exercise apparel comprises: a machine-readable label comprising data, wherein the machine readable label is disposed on a surface of the apparel, and the data comprises at least one of access to an exercise routine and an exercise routine.

These and other features, aspects and advantages of the present invention will become better understood with reference to the following drawings, description and claims.

### BRIEF DESCRIPTION OF THE DRAWINGS

FIG. 1 is a front view of the present invention shown in use;

FIG. 2 is a front view of the present invention;

FIG. 3 is a front view of the present invention;

FIG. 4 is a front detail view of an alternate embodiment of the present invention;

FIG. 5 is a front detail view of the alternate embodiment of the present invention; and

FIG. 6 is a front view of an alternate embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

The present invention includes fitness apparel that provides users with an exercise routine geared towards the user's athletic interests in a quick and easy manner. The present invention may incorporate current technology such as Quick Response ® (QR) codes, bar codes, and direct links onto exercise apparel to provide the wearer a direct link to a customized exercise. In certain embodiments, the exercise may be based on the type of exercise apparel and/or on a design displayed on the exercise apparel. The present invention provides immediate access to customized exercises geared to an identified fitness interest.

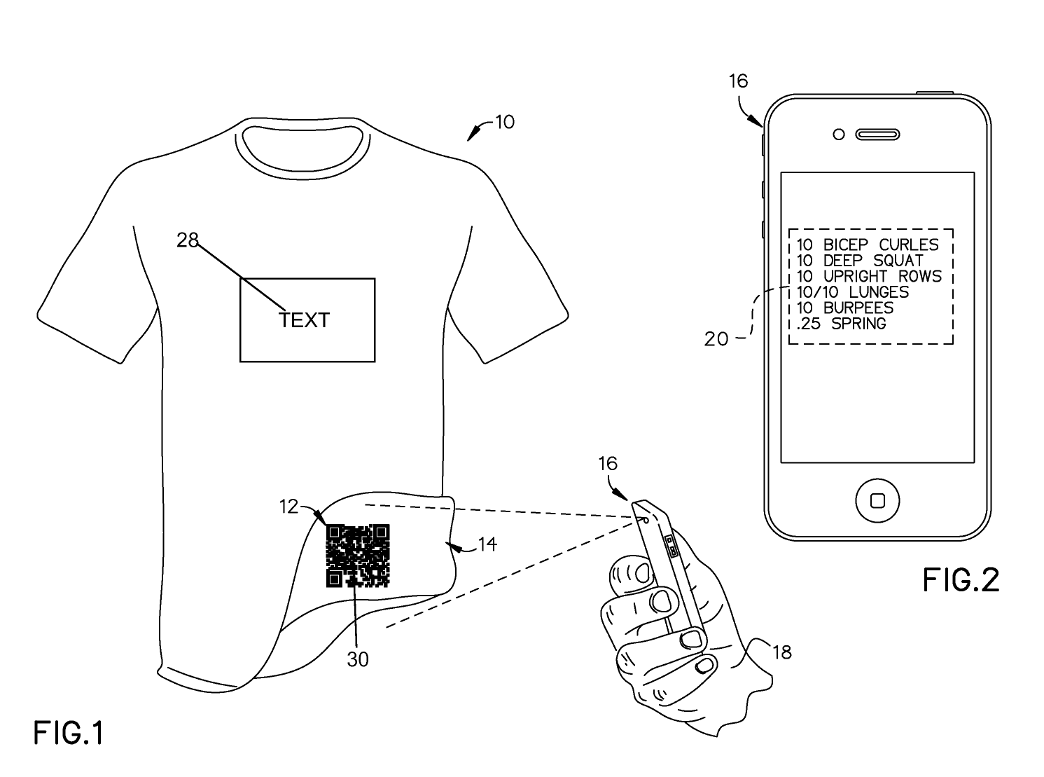

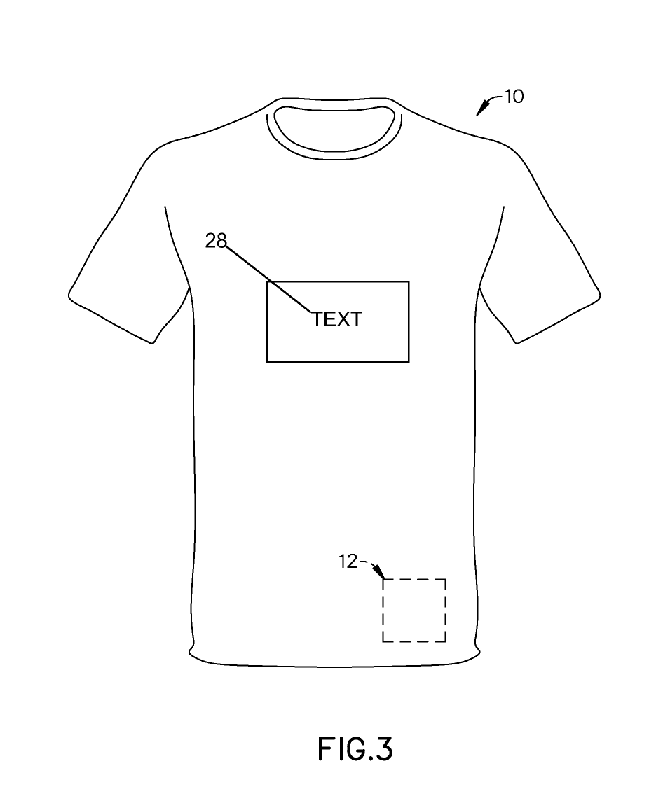

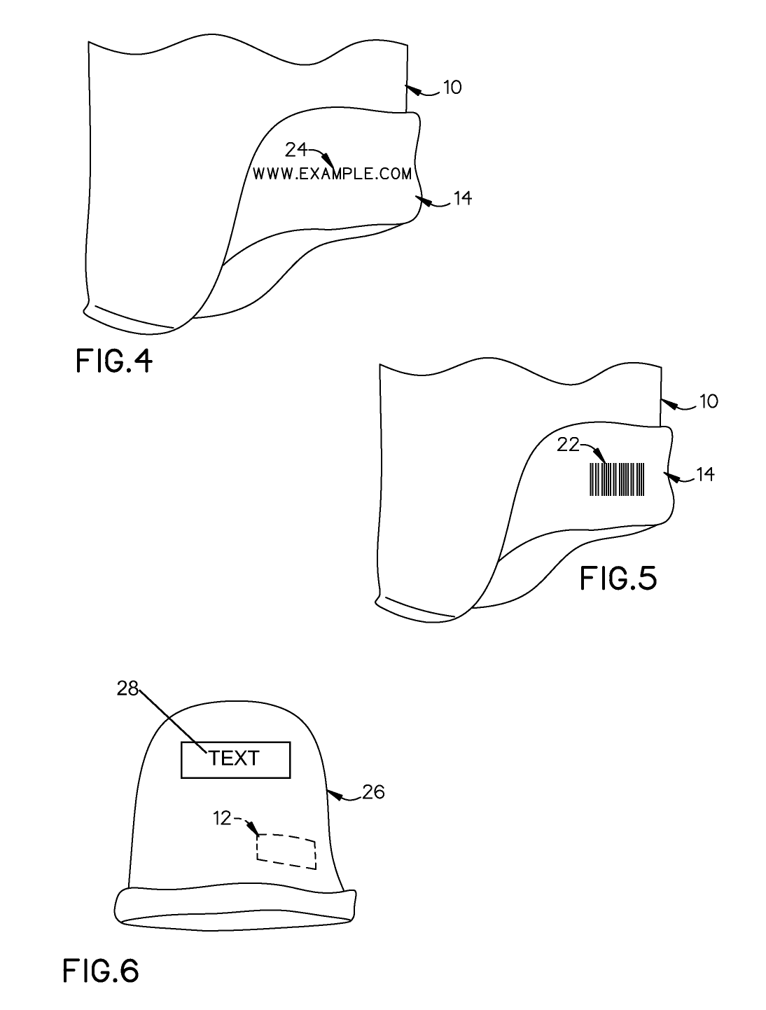

Referring to FIGS. 1 through 6, the present invention may include exercise apparel 10. The apparel 10 may include a machine-readable label 12. The machine readable label 12 may include data. The data may include either access to an exercise routine 20 over the internet or the exercise routine 20 itself. A computer 16, such as a smart phone, tablet, desktop, laptop, and the like may read the machine-readable label 12 and display the exercise routine 20 to the user 18.

The apparel 10 of the present invention may include exercise, fitness, sports or any type of activity apparel 10. The apparel 10 may include, but is not limited to, a shirt, a pair of pants, a pair of shorts, a pair of shoes, a pair of gloves, a hat 26, an over garment, and an undergarment. The machine-readable label 12 may be displayed on a surface 14 of the apparel 10. As illustrated in the Figures, the machine-readable label 12 may be displayed on the inside surface 14 of the apparel 10.

The machine-readable label 12 may include any label that may be read by a computer. In certain embodiments, the machine-readable label 12 may include at least one of a barcode 22, a matrix barcode 30, and a uniform resource locator 24 (URL). The machine-readable label 12 may link a user 18 directly to the exercise routine 20 or may provide access to the exercise routine 20. For example, the computer may read a matrix barcode 30 which may provide a link to an exercise routine 20. Alternatively, the computer may read a matrix barcode 30 that includes data including the exercise routine 20 and therefore immediately displays the exercise routine 20.

The exercise routine 20 may be related to different components of the present invention. For example, the present invention may include a display 28, which may include text or a design. The exercise routine 20 may correlate with the display 28. For example, the display 28 may include text such as “BIKE” or “RUNNER” and the exercise routine 20 may incorporate biking and running respectively. Alternatively, the type of apparel 10 may correlate with the exercise routine 20. For example, if the apparel 10 is running shoes, the exercise routine 20 may incorporate running, or if the apparel 10 is basketball shorts, the exercise routine 20 may incorporate basketball drills.

The present invention may further include a system for accessing an exercise routine 20. The system may include an apparel 10 having a machine-readable label 12 comprising data. The machine readable label 12 is disposed on a surface of the apparel 10. The system may further include a computer 16 having a user interface and configured to read the machine-readable label 12 and display the data. The data may include at least one of access to an exercise routine 20 and an exercise routine 20.

The present invention may further include a method of providing an exercise routine. The method may include: providing an apparel comprising a machine-readable label comprising data, wherein the machine readable label is disposed on a surface of the apparel; prompting a user to enter the machine readable label into a computer by at least one of manually entering the machine readable label and scanning the machine readable label; displaying an exercise routine on the computer once the machine readable label has been entered into the computer.

The computer-based data processing system and method described above is for purposes of example only, and may be implemented in any type of computer system or programming or processing environment, or in a computer program, alone or in conjunction with hardware. The present invention may also be implemented in software stored on a computer-readable medium and executed as a computer program on a general purpose or special purpose computer. For clarity, only those aspects of the system germane to the invention are described, and product details well known in the art are omitted. For the same reason, the computer hardware is not described in further detail. It should thus be understood that the invention is not limited to any specific computer language, program, or computer. It is further contemplated that the present invention may be run on a stand-alone computer system, or may be run from a server computer system that can be accessed by a plurality of client computer systems interconnected over an intranet network, or that is accessible to clients over the Internet. In addition, many embodiments of the present invention have application to a wide range of industries. To the extent the present application discloses a system, the method implemented by that system, as well as software stored on a computer-readable medium and executed as a computer program to perform the method on a general purpose or special purpose computer, are within the scope of the present invention. Further, to the extent the present application discloses a method, a system of apparatuses configured to implement the method are within the scope of the present invention.

It should be understood, of course, that the foregoing relates to exemplary embodiments of the invention and that modifications may be made without departing from the spirit and scope of the invention as set forth in the following claims.

What is claimed is:

1. A system for accessing an exercise routine comprising:
an apparel comprising a machine-readable label comprising data, wherein the machine readable label is disposed on a surface of the apparel; and
a computer comprising a user interface and wherein the computer is configured to read the machine-readable label and display the data,
wherein the data comprises at least one of access to an exercise routine and an exercise routine.

2. The system of claim 1, wherein the computer is a smart phone.

3. The system of claim 1, wherein the machine-readable label comprises at least one of a barcode, a matrix barcode, and a uniform resource locator.

4. The system of claim 1, wherein the apparel comprises a type of apparel comprising at least one of a shirt, a pair of pants, a pair of shorts, a pair of shoes, a pair of gloves, an over garment, and an undergarment.

5. The system of claim 4, wherein the type of apparel is related to a type of exercise routine.

6. The system of claim 1, wherein the apparel further comprises a display comprising at least one of a text and design, wherein the display is disposed on the surface of the apparel and is related to the type of exercise routine.

7. A method of providing a exercise routine comprising:
providing an apparel comprising a machine-readable label comprising data, wherein the machine readable label is disposed on a surface of the apparel;
prompting a user to enter the machine readable label into a computer by at least one of manually entering the machine readable label and scanning the machine readable label; and
displaying an exercise routine on the computer once the machine readable label has been entered into the computer.

8. The method as claimed in claim 7, wherein the computer is a smart phone.

9. The method as claimed in claim 7, wherein the machine-readable label comprises at least one of a barcode, a matrix barcode, and a uniform resource locator.

10. The method as claimed in claim 7, wherein the apparel comprises a type of apparel comprising at least one of a shirt, a pair of pants, a pair of shorts, a pair of shoes, a pair of gloves, a hat, an over garment, and an undergarment.

11. The method as claimed in claim 10, wherein the type of apparel is related to a type of exercise routine.

12. The method as claimed in claim 7, wherein the apparel further comprises a display comprising at least one of a text and a design, wherein the display is disposed on the surface of the apparel and is related to the type of exercise routine.

13. An exercise apparel comprising: a machine-readable label comprising data, wherein the machine readable label is disposed on a surface of the apparel, and the data comprises at least one of access to an exercise routine and an exercise routine.

14. The exercise apparel of claim 13, wherein the machine-readable label comprises at least one of a barcode, a matrix barcode, and a uniform resource locator.

15. The exercise apparel of claim 13, wherein the apparel comprises a type of apparel comprising at least one of a shirt, a pair of pants, a pair of shorts, a pair of shoes, a pair of gloves, an over garment, and an undergarment.

16. The exercise apparel of claim 15, wherein the type of apparel is related to a type of exercise routine.

17. The exercise apparel of claim 13, wherein the apparel further comprises a display comprising at least one of a text and design, wherein the display is disposed on the surface of the apparel and is related to the type of exercise routine.
